(19) United States
(12) Patent Application Publication
(10) Pub. No.: US 2025/0133221 A1
(43) Pub. Date: Apr. 24, 2025

(54) APPARATUS FOR ENCODING/DECODING FEATURE MAP AND METHOD FOR PERFORMING THEREOF

(71) Applicants: Electronics and Telecommunications Research Institute, Daejeon (KR); UNIVERSITY-INDUSTRY COOPERATION GROUP OF KYUNG HEE UNIVERSITY, Yongin-si (KR)

(72) Inventors: JooYoung LEE, Daejeon (KR); Youn Hee KIM, Daejeon (KR); Se Yoon JEONG, Daejeon (KR); Jin Soo CHOI, Daejeon (KR); Jung Won KANG, Daejeon (KR); Hui Yong KIM, Yongin-si (KR); Hye Won JEONG, Yongin-si (KR); Seung Hwan JANG, Yongin-si (KR); Yeong Woong KIM, Yongin-si (KR); Jang Hyun YU, Yongin-si (KR)

(73) Assignees: Electronics and Telecommunications Research Institute, Daejeon (KR); UNIVERSITY-INDUSTRY COOPERATION GROUP OF KYUNG HEE UNIVERSITY, Yongin-si (KR)

(21) Appl. No.: 18/912,827

(22) Filed: Oct. 11, 2024

(30) Foreign Application Priority Data
Oct. 11, 2023 (KR) 10-2023-0135463
Feb. 14, 2024 (KR) 10-2024-0021365
Apr. 22, 2024 (KR) 10-2024-0053699

(51) Int. Cl. H04N 19/169; G06V 10/77; G06V 10/82; H04N 19/124; H04N 19/13; H04N 19/189; H04N 19/30; H04N 19/70

(52) U.S. Cl. CPC H04N 19/169; G06V 10/7715; G06V 10/82; H04N 19/124; H04N 19/13; H04N 19/189; H04N 19/30; H04N 19/70

(57) ABSTRACT

A device for decoding a feature map according to the present disclosure comprises an image decoding unit to decode an image from a bitstream; an inverse format conversion unit to restore a feature map latent representation by converting a formation of a decoded image; and a feature map restoration unit to restore a multi-layer feature map from the feature map latent representation. Here, the feature map restoration unit restores the multi-layer feature map based on a learned neural network parameter.

### TECHNICAL FIELD

The present disclosure relates to a method and a device for encoding/decoding a feature group.

### BACKGROUND ART

A traditional image compression technology has been developed to ensure that when a compressed image is reconstructed, a reconstructed image is as similar as possible to the original based on human vision. In other words, an image compression technology has been developed towards minimizing a bit rate and maximizing the image quality of a reconstructed image at the same time.

As an example, an encoder receives an image as input to generate a bitstream through a transform and entropy encoding process for an input image, and a decoder receives a bitstream as input to reconstruct it to an image similar to the original.

To measure similarity between an original image and a reconstructed image, an objective image quality evaluation scale or a subjective image quality evaluation scale may be used. Here, Mean Squared Error (MSE), etc. which measures a difference in pixel values between an original image and a reconstructed image is mainly used as an objective image quality evaluation scale. Meanwhile, a subjective image quality evaluation scale means that a person evaluates a difference between an original image and a reconstructed image.

Meanwhile, as machine vision working performance has been improved, a growing number of machines, instead of persons, have watched and consumed an image. As an example, in fields such as a smart city, an autonomous car, an airport surveillance camera, etc., an increasing number of images are used based on machines, not persons.

Accordingly, recently, other than traditional image compression focusing on persons, there is a growing interest in an image compression technology centered on machine vision.

### DISCLOSURE

### Technical Problem

The present disclosure provides a method of extracting feature map latent representation from a multi-layer feature map and restoring the multi-layer feature map from the feature map latent representation.

The present disclosure provides a method of utilizing a learned neural network parameter for extracting the feature map latent representation and restoring the multi-layer feature map.

The present disclosure provides a method of learning a neural parameter based on a compression parameter.

The present disclosure provides a method of converting/inverse-converting the feature map latent representation to encode/decode thereof by the conventional code.

The technical objects to be achieved by the present disclosure are not limited to the above-described technical objects, and other technical objects which are not described herein will be clearly understood by those skilled in the pertinent art from the following description.

### Technical Solution

A device for decoding a feature map according to the present disclosure comprises an image decoding unit to decode an image from a bitstream; an inverse format conversion unit to restore a feature map latent representation by converting a formation of a decoded image; and a feature map restoration unit to restore a multi-layer feature map from the feature map latent representation. Here, the feature map restoration unit restores the multi-layer feature map based on a learned neural network parameter.

In a device for decoding a feature map according to the present disclosure, the feature map restoration unit comprises at least one of a compression parameter-dependent restoration unit, that is learned based on a compression parameter available for the image decoding unit, or a compression parameter-independent restoration unit, that is learned without considering the compression parameter available for the image decoding unit.

In a device for decoding a feature map according to the present disclosure, the compression parameter represents a quantization parameter.

In a device for decoding a feature map according to the present disclosure, the compression parameter-dependent restoration unit comprises a compression parameter adaptation unit learned by the compression parameters; and a channel adaption unit adjusting a number of channels input to the compression parameter adaptation unit.

In a device for decoding a feature map according to the present disclosure, the channel adaption unit is configured to convert a combined image, generated by combining channels of the feature map latent representation and the compression parameters, according to a number of channels of the feature map latent representation.

In a device for decoding a feature map according to the present disclosure, the feature map restoration unit is firstly learned based on compression noise of a first internal codec, including an entropy encoding unit and an entropy decoding unit which are learnable by error back propagation.

In a device for decoding a feature map according to the present disclosure, a neural network parameter, that is firstly learned, is fine-tuned based on compression noise of a second codec, including an image encoding unit and an image decoding unit which are not learnable by error back propagation.

In a device for decoding a feature map according to the present disclosure, the inverse format conversion unit comprises an inverse quantization unit to perform inverse quantization on the decoded image; and a channel rearrangement unit to perform a channel rearrangement for an inverse-quantized image.

In a device for decoding a feature map according to the present disclosure, the inverse quantization is performed based on a maximum value and a minimum value among feature values, and information representing the maximum value and the minimum value is explicitly decoded from the bitstream.

In a device for decoding a feature map according to the present disclosure, the channel rearrangement represents restoration of channels that are arranged in spatial, temporal or spatiotemporal into an original form.

A device for encoding a feature map according to the present disclosure comprises a feature map latent extraction unit to extract a feature map latent representation from a multi-layer feature map; a format conversion unit to convert a format of the feature map latent representation; and an image decoding unit to generate bitstream by encoding a format-converted image. Here, the feature map latent representation extraction unit extracts the feature map latent representation based on a learned neural network parameter.

In a device for encoding a feature map according to the present disclosure, the device comprises a channel arrangement unit for performing channel conversion for the feature map latent representation; and a quantization unit to perform a quantization on a channel converted image.

In a device for encoding a feature map according to the present disclosure, the quantization is performed based on a maximum value and a minimum value among feature values, and information representing the maximum value and the minimum value is explicitly signaled via the bitstream.

In a device for encoding a feature map according to the present disclosure, the channel arrangement represents arranging channels of the feature map latent representation in a spatial, temporal or spatiotemporal.

A method for decoding a feature map according to the present disclosure comprises decoding an image from a bitstream; restoring a feature map latent representation by converting a formation of a decoded image; and restoring a multi-layer feature map from the feature map latent representation. Here, restoring the multi-layer feature map is based on a learned neural network parameter.

According to the present disclosure, a computer readable recording medium recording the feature map encoding/decoding method may be provided.

The technical objects to be achieved by the present disclosure are not limited to the above-described technical objects, and other technical objects which are not described herein will be clearly understood by those skilled in the pertinent art from the following description.

### Technical Effect

According to the present disclosure, a method for extracting a feature map latent representation from a multi-layer feature map and restoring the feature map latent representation into a multi-layer feature map may be provided.

According to the present disclosure, a method for utilizing a learned neural network parameter in extracting a feature map latent representation and restoring a multi-layer feature map may be provided.

According to the present disclosure, a method for learning a neural network parameter based on a compression parameter may be provided.

According to the present disclosure, a method for converting/inverse converting the format of a feature map latent representation may be provided so that encoding/decoding may be performed using a general codec.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is an example of the results of a machine task that perform object detection and classification using Fast R-CNN, one of artificial neural networks.

FIG. 2 is a diagram illustrating a multi-layer feature map.

FIG. 3 shows an artificial neural network model of the Mask-RCNN structure.

FIG. 4 illustrates a multi-layer feature map Pₖ extracted through FPN of Mask R-CNN.

FIG. 5 shows an example of extracting a multi-layer feature map based on YOLO v3.

FIG. 6 illustrates an example in which a feature map extraction unit and a task performing unit exist in different devices.

FIG. 7 is a schematic diagram of a neural network-based image encoding/decoding method according to the present disclosure.

FIG. 8 is a diagram showing a neural network-based multi-layer feature map encoding/decoding process.

FIG. 9 is a diagram illustrating a multi-layer feature map encoding/decoding process based on a neural network including a gain unit and an inverse gain unit.

FIG. 10 is a block diagram of an image encoder and an image decoder according to an embodiment of the present disclosure.

FIG. 11 shows a system configuration for learning a neural network-based multi-layer feature map encoding model.

FIG. 12 is for explaining the learning method of the feature map latent representation extraction unit and the feature map restoration unit.

FIG. 13 is a block diagram of an image decoder including a fine-tunable feature map restoration unit.

FIG. 14 illustrates a configuration of a fine-tunable feature map restoration unit according to an embodiment of the present disclosure.

FIG. 15 and FIG. 16 are flowcharts of a feature map encoding method and a feature map decoding method according to the present disclosure, respectively.

FIG. 17 illustrates an example of extracting feature map latent representation through sequential fusion in the feature map latent representation extraction unit.

FIGS. 18 to 23 illustrate configuration diagrams of a fine-tunable feature map restoration unit including a compression parameter-independent feature map restoration unit and a compression parameter-dependent feature map restoration unit according to the present disclosure.

FIG. 24 shows an example of converting compression parameters using the one-hot encoding method.

FIG. 25 illustrates a channel adaptation unit according to an embodiment of the present disclosure.

FIGS. 26 and 27 illustrate examples in which the fine-tunable feature map restoration unit performs fine-tuning learning on compression parameters available to the image decoding unit.

FIG. 28 illustrates a configuration of a general feature map.

FIGS. 29 to 31 illustrate a spatial arrangement method, a temporal arrangement method, and a spatiotemporal arrangement method, respectively.

### DETAILED DESCRIPTION OF DISCLOSURE

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from another element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

Machine tasks based on image processing using artificial neural networks (ANNs) are getting widely used. For example, machine vision tasks such as object classification, object recognition, object detection, object segmentation, or object tracking from input images, or image processing tasks such as improving resolution of input images (super-resolution) or frame interpolation for input images are being increasingly utilized.

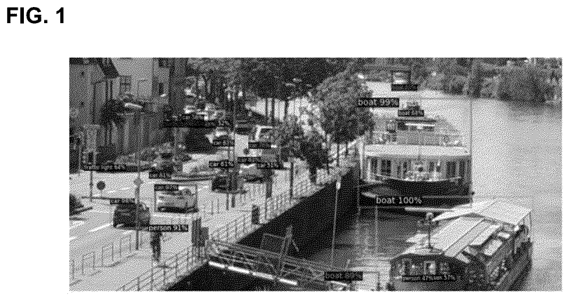

FIG. 1 is an example of the results of a machine task that perform object detection and classification using Fast R-CNN, one of artificial neural networks.

For the machine task described above, necessary of image compression technology for machine vision, not human vision, is hugely increased.

Image compression technology for machine vision minimizes the amount of compression bits, but unlike image compression technology for human vision, it has goals to maximize the performance of machine vision tasks through a restored feature map, not the image quality of restored images.

Meanwhile, an artificial neural network model that performs machine tasks may include a feature map extraction unit that extracts features from input data or input image, and a task performing unit that performs actual a machine task based on the extracted features.

When data input to an artificial neural network model is an image, the features extracted from the feature map extraction unit may be called a feature map. Accordingly, in this disclosure, the features extracted from the feature map extraction unit are called a ‘feature map.’ However, even when the extracted features are not in the form of a map, the embodiments described in this disclosure also may be applied.

The embodiments described in this disclosure may be applied to a multi-layer feature map.

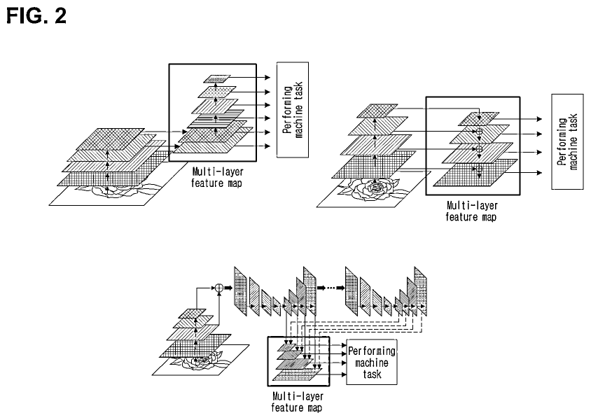

FIG. 2 is a diagram illustrating a multi-layer feature map.

The multi-layer feature map has a structure in which feature maps with different resolutions form multiple layers. A feature map in a higher layer has a lower resolution, and a feature map in a lower layer has a higher resolution. Accordingly, the multi-layer feature map may also be called a pyramid-structured feature map. Meanwhile, the resolutions of feature maps within the same layer may be mutually same.

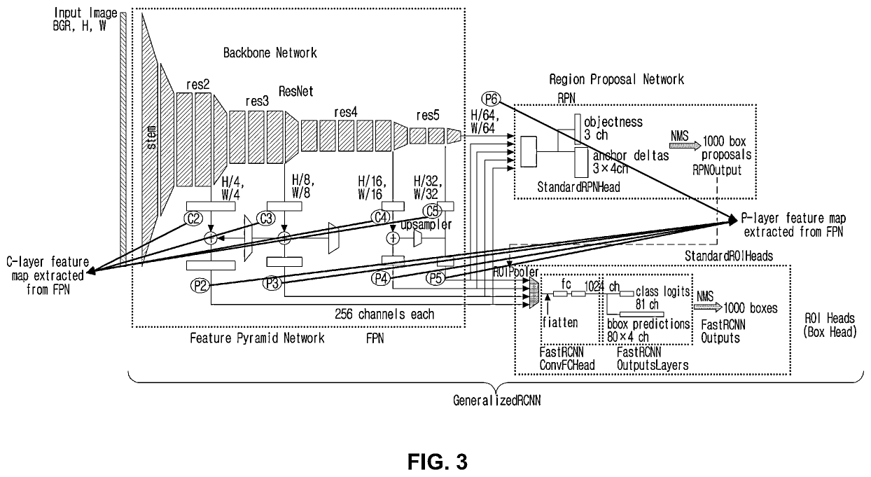

FIG. 3 shows an artificial neural network model of the Mask-RCNN structure.

The artificial neural network model of the Mask-RCNN structure illustrated in FIG. 3 may be mainly utilized for object region segmentation machine task.

In the example illustrated in FIG. 3, a feature pyramid network (FPN) corresponds to a multi-layer feature map extraction unit, and a region proposal network (RPN) and a region of interest heads (ROI Heads) correspond to a machine task performing unit.

In the example illustrated in FIG. 3, the feature pyramid network (FPN) is exemplified as extracting a C-layer feature map and a P-layer feature map. Here, each of the C-layer feature map and the P-layer feature map may be a multi-layer feature map.

The embodiments described below will be described with a focus on the P-layer feature map, but the embodiments described in the present disclosure may be equally applied to a feature map of a different type than the P-layer feature map. Meanwhile, the embodiments described in the present disclosure may be equally applied to not only multi-layer feature maps but also single-layer feature maps.

The feature map may be represented as a two-dimensional array. Accordingly, the size of the feature map can be defined as (width×height).

Meanwhile, a feature map belonging to an arbitrary layer can be composed of one or more channels. Accordingly, the feature map of each layer can be represented as a three-dimensional array having a size of (width×height×number of channels).

That is, when a feature map belonging to layer k is called Fₖ, the feature map Fₖ may be represented as a three-dimensional array Fₖ [x][y][c] composed of extracted feature values. Here, x and y represent the horizontal and vertical positions of a feature value, respectively, and c represents the channel index.

For example, a multi-layer feature map Cₖ or a multi-layer feature map Pₖ extracted from FPN may be a multi-layer feature map Fₖ of the present invention.

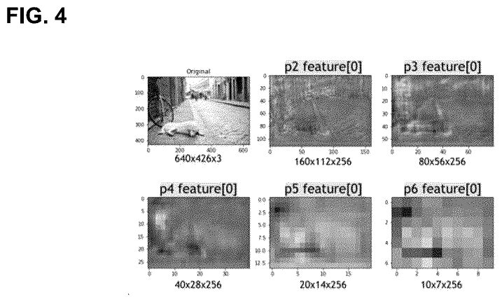

FIG. 4 illustrates a multi-layer feature map Pₖ extracted through FPN of Mask R-CNN.

In FIG. 4, only the feature map in the first channel of the feature map belonging to each layer is illustrated.

In the multi-layer feature map Pₖ extracted from FPN, the resolutions of the feature maps belonging to different layers may be different from each other. For example, as in the example illustrated in FIG. 4, as the layer becomes deeper, the width and height of the feature map may become smaller.

On the other hand, even if the feature maps belong to different layers, the number of channels may be the same. For example, as in the example illustrated in FIG. 4, the feature map of each layer may consist of 256 channels.

The FPN, i.e., the feature map extraction unit, may extract feature maps of five layers, i.e., P₂ to P₆.

Meanwhile, when encoding the extracted feature maps, all of the extracted feature maps of the five layers may be encoded.

Alternatively, encoding/decoding of the layer with the smallest resolution may be omitted/skipped, and the layer whose encoding/decoding has been omitted/skipped may be restored using the neighboring layer.

For example, in the example shown in FIG. 4, only the feature maps of four layers, for example, P₂ to P₅, may be encoded, and the layer whose encoding has been omitted/skipped may be derived from the feature map of the layer that is explicitly encoded/decoded. For example, when encoding/decoding of the feature map P₆ is omitted/skipped, the feature map P₆ may be restored based on the decoded feature map P₅.

In a model for performing a machine task such as YOLO v3, a multi-layer feature map may be extracted in a similar way to the P layer feature map of FPN, and these can be used for performing a machine task.

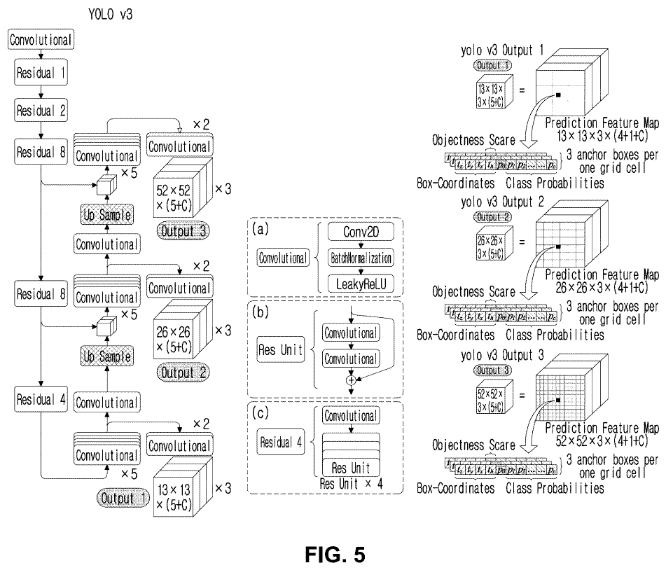

FIG. 5 shows an example of extracting a multi-layer feature map based on YOLO v3.

In FIG. 5, it is exemplified that a multi-layer feature map consisting of three layers (i.e., (Output1, Output2, Output3)) is extracted and machine task is performed based on the extracted multi-layer feature map.

Specifically, in FIG. 5, it is exemplified that darknet 53, which has a pyramid structure similar to FPN, within YOLO v3, utilized as a multi-layer feature map extraction unit.

As explained in FIG. 4, when encoding the extracted feature map, all three layers may be encoded/decoded.

Alternatively, encoding/decoding may be omitted/skipped for the feature map of the layer with the smallest resolution among the extracted feature maps. In this case, the feature map of the layer whose encoding/decoding is omitted/skipped may be restored based on the feature map of another layer that is explicitly encoded/decoded.

Meanwhile, as machine task is used not only on a huge server but also on a device with relatively low computing power such as a mobile device, there may occur a case where the feature map extraction unit and the task performing unit do not exist within the same device.

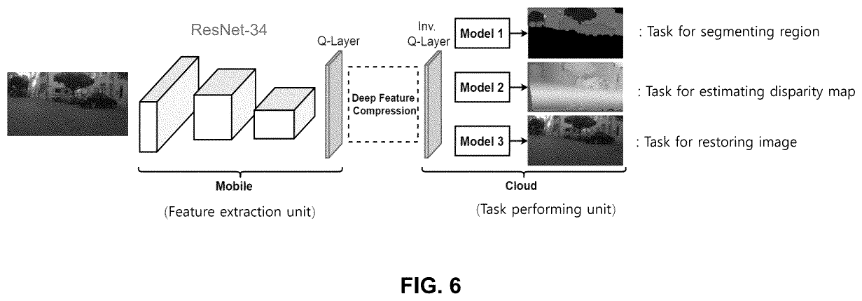

FIG. 6 illustrates an example in which a feature map extraction unit and a task performing unit exist in different devices.

Specifically, in FIG. 6, the feature map extraction unit exists in a mobile device, while the task performing unit for performing a machine task such as object segmentation, disparity map estimation, or image restoration exists in a cloud server.

In this case, a feature map extracted from a mobile device may be transmitted to a server, and a result of the machine task may be fed back to the mobile device from the server.

As in the example illustrated in FIG. 6, if the feature map extraction unit and the task performing unit are separated, the extracted feature map should be transmitted to the task performing unit. Accordingly, a feature map encoding/decoding method may be required to minimize the amount of data of the feature map to be transmitted and stored, while minimizing the degradation of the task performance.

Even if the feature map extraction unit and the task performing unit present in one device, there may be cases where the extracted feature map is stored and later utilized by the task performing unit. In this case as well, a feature map encoding/decoding method may be required to minimize the amount of data of the feature map to be stored.

Accordingly, the present disclosure proposes a method for encoding/decoding a feature map, specifically, a feature map, extracted by the feature map extraction unit.

In the present disclosure, ‘image’ may refer to various types of images, such as a natural image acquired through a camera, a computer graphic, a holographic image, a feature map image extracted through a neural network, or a ultrasound image.

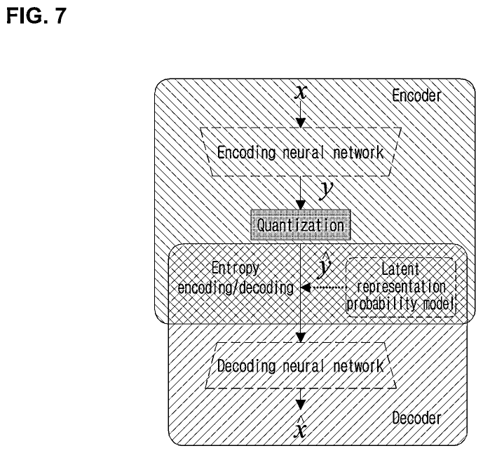

FIG. 7 is a schematic diagram of a neural network-based image encoding/decoding method according to the present disclosure.

The neural network-based image encoding/decoding method according to the present disclosure may be implemented through an encoding neural network, a decoding neural network, quantization, a latent representation probability model, entropy encoding, and entropy decoding, etc.

First, in the encoder, an image to be encoded (i.e., an input image) x may be converted into a latent representation y through an encoding neural network.

Here, the latent representation may represent at least one of a latent vector, a latent representation, or a latent feature map.

In the encoder, each component yᵢ of the latent representation y is quantized.

The quantized latent representation ŷ may be converted into a bitstream through entropy encoding based on a learnable latent representation probability model p_{ŷ}(ŷ) and transmitted to a decoder.

The decoder receives the bitstream and restores the quantized latent representation ŷ through entropy decoding based on the same latent representation probability model in the encoder.

In addition, the decoding neural network may output a restored image \hat{x} in response to the input of the quantized latent representation ŷ.

Meanwhile, in the example illustrated in FIG. 7, the block expressed by the dotted line indicates a learnable parameter or a learnable neural network.

The neural network parameters of the learnable blocks illustrated in FIG. 7 may be learned through a loss function and a backpropagation algorithm.

Meanwhile, the multi-layer feature map is composed of several feature maps with different spatial resolutions. Accordingly, a different method may be required for encoding/decoding the multi-layer feature map than when encoding/decoding a natural image.

Therefore, in the present disclosure, a neural network-based image encoding/decoding method is proposed for the input image of a multi-layer feature map {Fₖ} (k is 1 to L, L is the number of layers). Meanwhile, a smaller value of the variable k may mean a feature map of a layer with a larger spatial resolution.

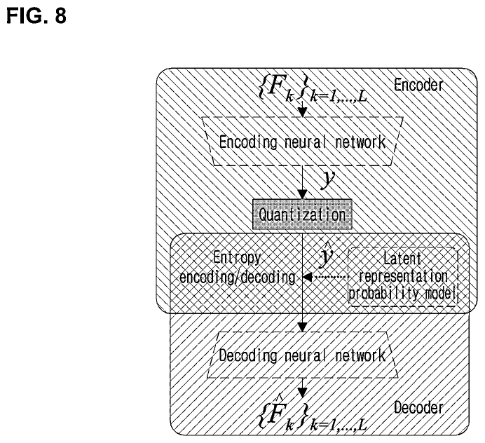

FIG. 8 is a diagram showing a neural network-based multi-layer feature map encoding/decoding process.

In the encoder, the multi-layer feature map {Fₖ} to be encoded may be converted into a latent representation y through an encoding neural network.

In addition, the encoder may quantize each component yᵢ of the latent representation y.

The quantized latent representation ŷ may be converted into a bitstream through entropy encoding based on a learnable latent representation probability model p_{y}(ŷ) and transmitted to the decoder.

In the decoder, once the bitstream is received, the quantized latent representation ŷ may be restored through entropy decoding based on the same latent representation probability model in the encoder.

In addition, the decoding neural network generates a restored multi-layer feature map {\hat{F}ₖ} in response to the input of the quantized latent representation ŷ.

Meanwhile, in the example illustrated in FIG. 8, the blocks represented by dotted lines represent learnable parameters or learnable neural networks.

The neural network parameters of the learnable blocks illustrated in FIG. 8 may be learned through a loss function and a backpropagation algorithm.

Meanwhile, in neural network-based image encoding/decoding, a gain unit (GU) and an inverse gain unit (IGU) may be used to support variable bit rate encoding/decoding.

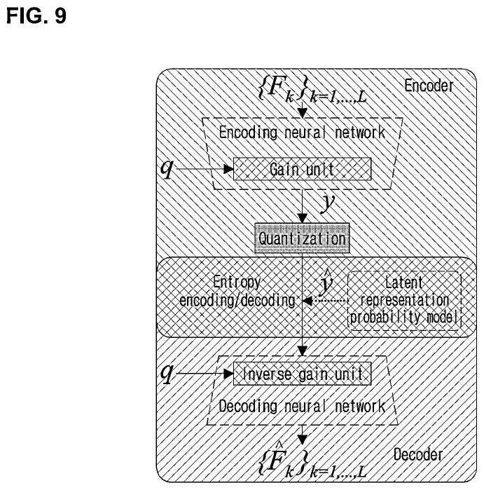

FIG. 9 is a diagram illustrating a multi-layer feature map encoding/decoding process based on a neural network including a gain unit and an inverse gain unit.

As in the example illustrated in FIG. 9, the gain unit may be located at the end of the encoding neural network. On the other hand, the inverse gain unit may be located at the beginning of the decoding neural network.

The gain unit may scale each channel of the input feature map using one of Q gain vectors {v_{q}} (GV: Gain Vector, q is 1 to Q) for variable bit rate encoding. Here, the integer q represents a bit rate level, and Q represents the number of bit rate levels for variable bit rate encoding. q may have a value greater than 0.

The gain unit may scale the latent representation (hereinafter referred to as intermediate latent representation τ) immediately before passing through the gain unit according to the following equation 1.

$$y [ c ] [ h ] [ w ] = τ [ c ] [ h ] [ w ] \times {v}_{q} [ c ] \qquad [ Equation 1 ]$$

In the above equation 1, c (having values from 1 to C) represents a channel index of the intermediate latent representation t. The length of the gain vector may be equal to C. h (having values from 1 to H) and w (having values from 1 to W) represent vertical and horizontal coordinates of the intermediate latent representation t, respectively. H and W may represent the height and width of the feature map.

The inverse gain unit may scale each channel of the input feature map using one of the inverse gain vectors {u_{q}} (q is 1 to Q) corresponding to the gain vector.

The intermediate latent representation n output from the inverse gain unit may be obtained through a scaling process as in the following equation 2.

$$η [ c ] [ h ] [ w ] = \hat{y} [ c ] [ h ] [ w ] \times {u}_{q} [ c ] \qquad [ Equation 2 ]$$

In the above equation 2, c (having values from 1 to C) represents the channel index of the quantized latent representation ŷ. The length of the inverse gain vector may be equal to C. h (having values from 1 to H) and w (having values from 1 to W) represent the vertical and horizontal coordinates of the intermediate latent representation ŷ, respectively. H and W may represent the height and width of the feature map.

Each component value of the gain vector and inverse gain vector pair (v_{q}, u_{q}) may be optimized through learning to satisfy the bit rate constraint corresponding to the given bit rate level q.

As a result, the bit rate and the restored image quality of the current image to be encoded may be determined according to the bit rate level q given to the gain unit and the inverse gain unit.

As described above, encoding of a neural network-based multi-layer feature map may be configured through neural networks composed of learnable parameters. An encoding model including the above neural networks may be called a neural network-based multi-layer feature map encoding model.

Meanwhile, the learning of the neural network may be based on a backpropagation algorithm. Through the backpropagation algorithm, the parameters and weights of the neural network may be updated to minimize a specific loss function calculated from learning data.

When learning a neural network-based multi-layer feature map encoding model, a rate-distortion optimization method or a rate-performance optimization method may be used.

The rate-distortion optimization method is to perform learning so as to simultaneously minimize the distortion, between the input multi-layer feature map and the restored multi-layer feature map, and the bit rate of the bit stream, transmitted from the encoder to the decoder.

The rate-performance optimization method is to learn to simultaneously minimize the performance of machine tasks, performed based on the restored multi-layer feature map, and the bit rate of the bitstream, transmitted from the encoder to the decoder.

The distortion loss function used in the neural network-based multi-layer feature map encoding model may be obtained by a weighted sum of the mean square error (MSE) or MS-SSIM (Multi-Scale Structural Similarity Index Measure) between the input multi-layer feature map {Fₖ} and the restored multi-layer feature map { [symbol] }, as in Equation 3.

Meanwhile, when calculating the weighted sum, the weight wₖ may be set individually for each layer.

$${L}_{D} = {E}_{x ∼ {p}_{x}} ( {\sum }_{k = 1 , … , L} {w}_{k} \times D ( {F}_{k} , {\hat{F}}_{k} ) ) \qquad [ Equation 3 ]$$

In the above equation 3, D represents a distortion function such as MSE or MS-SSIM.

The bit rate may be approximated by the cross-entropy between the probability distribution of the latent representation estimated by the latent representation probability model and the actual latent representation. Equation 4 shows an example of calculating the bit rate.

$${L}_{R} = {E}_{x ∼ {p}_{x}} ( - log {p}_{\hat{y}} ( \hat{y} ) ) \qquad [ Equation 4 ]$$

The machine task loss function Lₚ represents the performance of the machine task performed by the compressed and restored multi-layer feature map. The machine task performance may be calculated by comparing the correct answer label and the inference result of the machine task.

At this time, at least one of the classification loss function, the bounding box loss function, or the mask loss function may be used depending on the type of the machine task. However, embodiments according to the present disclosure may be performed based on a loss function of a different type than enumerated ones.

The loss function L_{RD} for rate-distortion optimization may be obtained based on the distortion loss function L_{D} and the cross entropy-based loss function L_{R}. As an example, equation 5 shows an example of deriving the loss function L_{RD}.

$${L}_{RD} = {L}_{R} + λ \times {L}_{D} \qquad [ Equation 5 ]$$

Meanwhile, in deriving the loss function L_{RD}, a variable λ may be used to adjust the ratio between the distortion loss function L_{D} and the cross entropy-based loss function L_{R}. Based on the variable λ, the desired restoration quality level and bit rate may be determined. For example, the larger the value of the variable λ, represents the higher the restoration quality level.

The loss function L_{RP} for rate-performance optimization may be obtained according to Equation 6.

$${L}_{RP} = {L}_{R} + λ \times {L}_{P} \qquad [ Equation 6 ]$$

As in the example of equation 6, the loss function L_{RP} may be obtained based on the performance loss function Lₚ and the cross entropy-based loss function L_{R}.

Meanwhile, in deriving the loss function L_{RP}, a variable λ may be used to adjust the ratio between the performance loss function Lₚ and the cross entropy-based loss function L_{R}. Based on the variable λ, a desired restoration quality level and bit rate may be determined. For example, the larger the value of the variable λ, represents the higher the machine task performance.

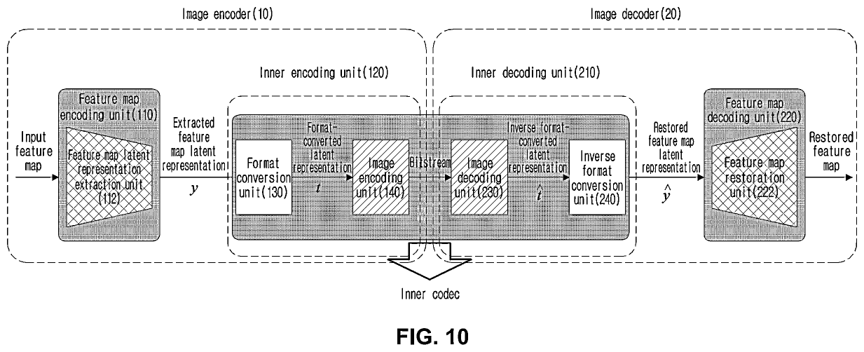

FIG. 10 is a block diagram of an image encoder and an image decoder according to an embodiment of the present disclosure.

When the feature map extraction unit and the task performing unit are implemented as separate devices, the image encoder may represent a device including the feature map extraction unit, and the image decoder may represent a device including the task performing unit.

Alternatively, when the feature map extraction unit and the task performing unit are implemented as one device, the image encoder and the image decoder may be in the same device.

Referring to FIG. 10, the image encoder 10 may include a feature map encoding unit 110 and an internal encoding unit 120, and the image decoder 20 may include an internal decoding unit 210 and a feature map decoding unit 220.

Meanwhile, the internal encoding unit 120 may include a format conversion unit 130 and an image encoding unit 140, and the internal decoding unit 210 may include an image decoding unit 230 and an inverse format conversion unit 240.

In addition, the internal encoding unit 120 and the internal decoding unit 210 that actually encode/decode an image derived from the extracted feature map may be referred to as an inner codec.

The feature map encoding unit 110 of the image encoder 10 may extract a feature map latent representation y from an input feature map. Specifically, the above operation may be performed through the feature map latent representation extraction unit 112 in the feature map encoding unit 110.

The feature map input to the feature map encoding unit 110 may be a single-layer feature map or a multi-layer feature map.

As described above, the feature map latent representation may represent one of a latent vector, a latent representation, or a latent feature map.

In the format conversion unit 130 of the internal encoding unit 120, the latent representation y is converted into a format-converted latent representation t. The format conversion unit 130 may include a feature map arrangement unit for arranging feature maps and a quantization unit for quantizing feature values.

In the image encoding unit 140 of the internal encoding unit 120, the latent representation t whose format has been converted is encoded to generate a bitstream.

In the image decoding unit 230 of the internal decoding unit 210, the bitstream is decoded to generate a latent representation \hat{t} whose format has been converted.

In the inverse format conversion unit 240 of the internal decoding unit 210, the latent representation \hat{t} whose format has been converted is converted (i.e., inverse-converted) to generate a restored latent representation ŷ. By performing the format inverse conversion, the restored latent representation ŷ may have the same format as the original latent representation t. The inverse format conversion unit 240 may include a feature map rearrangement unit for restoring the array-converted feature maps to the original array and a dequantization unit for dequantizing the quantized feature values.

The feature map decoding unit 220 may restore the restored latent expression ŷ to a feature map. Specifically, the above operation may be performed through the feature map restoration unit 222 in the feature map decoding unit 220.

Meanwhile, the standard compression codec (e.g., HEVC or VVC, etc.) mainly used in the internal encoding unit 120 and the internal decoding unit 210 has a structure that cannot be differentiated. Accordingly, when the standard compression codec is applied, end-to-end learning is impossible. To solve this problem, after removing the internal codec (i.e., the internal encoding unit 120 and the internal decoding unit 210), the feature map latent representation output from the feature map latent representation extraction unit 112 is used as the input of the feature map restoration unit 222, so that a neural network-based multi-layer feature map encoding model can be learned.

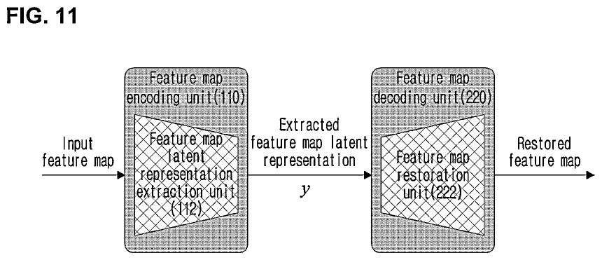

FIG. 11 shows a system configuration for learning a neural network-based multi-layer feature map encoding model.

In FIG. 11, learning is performed based on a structure in which an internal codec is removed from the image encoder 10 and image decoder 20 shown in FIG. 10.

Meanwhile, in the example shown in FIG. 11, if the internal codec is removed, the compression noise that occurs during image compression cannot be learned. Accordingly, a neural network-based multi-layer feature map encoding model may be learned using the distortion loss function L_{D} or the machine task loss function Lₚ.

However, if a multi-layer feature map encoding model is learned using only the distortion loss function or the machine task loss function, the compression ratio cannot be considered. In order for the feature map latent expression extraction unit 112 and the feature map restoration unit 222 to learn considering the compression noise in the internal codec, the learning method may be optimized by using at least one of the rate-distortion loss function of Equation 5 or the rate-machine task loss function of Equation 6.

Hereinafter, a learning method using at least one of the rate-distortion loss function or the rate-machine task loss function will be described in detail.

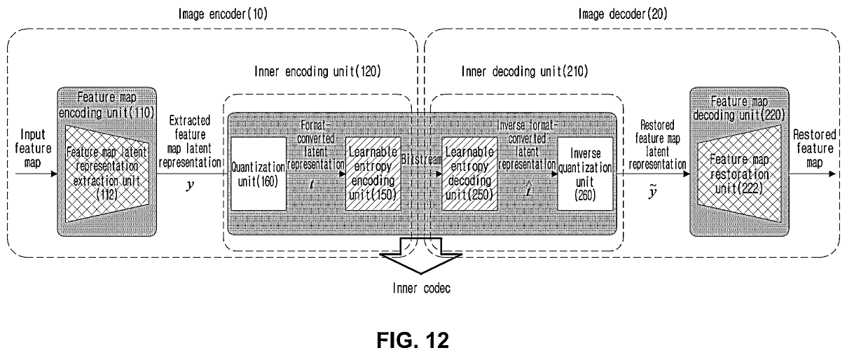

FIG. 12 is for explaining the learning method of the feature map latent representation extraction unit and the feature map restoration unit using an internal codec based on neural network.

According to the example illustrated in FIG. 12, the internal encoder 120 may further include a quantization unit 160 and a learnable entropy encoder 150 for learning neural network parameters, and the internal decoder 130 may further include a learnable entropy decoder 250 and a dequantization unit 260 for learning neural network parameters.

For convenience of explanation, in some embodiments of the present disclosure, the internal codec is named as a first internal codec or a second internal codec according to the configuration of the internal codec. For example, the first internal codec may include a learnable entropy encoder 150 and a learnable entropy decoder 250, and the second internal codec may include an image encoder and an image decoder for performing a machine task.

In the present disclosure, even if no prefix such as ‘first’ or ‘second’ is present, it will be clearly understood whether the internal codec is the first internal codec or the second internal codec depending on the purpose/use of the internal codec.

In FIG. 12, the quantization unit 160 may perform uniform quantization on all components yᵢ of the fused latent representation y. When the quantization unit 160 performs uniform quantization, a normal rounding operation may be used, and quantization may be replaced with a process of adding uniform noise so that a backpropagation algorithm can be used. The uniform noise may be a value between −0.5 and 0.5.

In order to optimize the feature map latent representation extraction unit 112 and the feature map restoration unit 222, a neural network based first internal codec, comprising the learnable entropy encoding unit 150 of the feature map latent representation and the learnable entropy decoding unit 250 of the feature map latent representation, may be used. That is, the configuration of a non-neural network based second internal codec for actual encoding/decoding (i.e., the image encoding unit 140 and the image decoding unit 230) and the configuration of the first internal codec for learning (i.e., the learnable entropy encoding unit 250 and the learnable entropy decoding unit 150) may be different.

By using a neural network based internal codec, the whole of the internal codec, the feature map encoding unit 110 and the feature map decoding unit 220 can be learned end-to-end, thus, the compression ratio and distortion can be considered simultaneously through the rate-distortion loss function during learning of the feature map encoding model.

Meanwhile, since the configuration of the internal codec for learning (i.e., the first internal codec) and the configuration of the internal codec for actual image encoding/decoding (i.e., the second internal codec) are different, the compression noise may be different between the two cases. Accordingly, the feature map restoration unit 222 may be replaced with a fine-tunable feature map restoration unit 224 so that the feature map restoration unit 222 can learn the compression noise of the second internal codec, not the compression noise of the first internal codec.

Specifically, \tilde{y}, which is the output of the first internal codec, and ŷ, which is the output of the second internal codec, may be different from each other. Therefore, a process is required in which a feature map restoration unit 222 optimized to receive \tilde{y} and restore a feature map is converted into a fine-tunable feature map restoration unit 224 optimized to receive ŷ and restore a feature map.

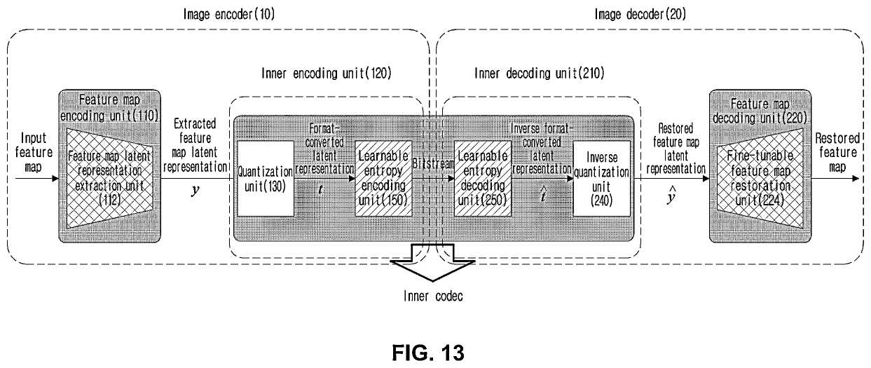

FIG. 13 is a block diagram of an image decoder including a fine-tunable feature map restoration unit.

In the example illustrated in FIG. 13, the feature map decoding unit 220 is exemplified as including a fine-tunable feature map restoration unit 224, rather than a general feature map restoration unit 222.

Specifically, in the present disclosure, a fine-tunable feature map restoration unit (224) may be used instead of a general feature map restoration unit (222) so as to minimize the mismatch between the compression noise, occurred from the first internal codec, that is learned by the feature map restoration unit 222 and the compression noise of the second internal codec that is actually used.

Meanwhile, the fine-tunable feature map restoration unit (224) according to the present disclosure may be an improved version of the general feature map restoration unit (222) to enable fine-tuning learning.

Hereinafter, a method of obtaining a fine-tunable feature map restoration unit 224 through a two-step learning method using a second internal codec will be described.

As in the example illustrated in FIG. 12, through the first-stage learning, the feature map latent representation extraction unit 112 and the feature map restoration unit 222 may be optimized using the neural network based first internal codec that can be learned by error backpropagation. The first internal codec may use an entropy encoding and entropy decoding method used in a typical neural network-based image compression model. The examples illustrated in FIGS. 8 and 9 are examples of the first internal codec, and may be understood by referring to the following reference document.

He, Dailan, et al. “Elic: Efficient learned image compression with unevenly grouped space-channel contextual adaptive coding.” Proceedings of the IEEE/CVF Conference on Computer Vision and Pattern Recognition. 2022.

The example illustrated in FIG. 13 shows a method of converting a general feature map restoration unit 222 into a fine-tunable feature map restoration unit 224 through two-stage learning. Specifically, since the compression noise (i.e., \tilde{y}−y) due to the first internal codec may be different from the compression noise (i.e., \tilde{y}−y) due to the second internal codec to be actually used, the feature map restoration unit may be fine-tuned by using the feature map latent representation extraction unit 112 and the feature map restoration unit 222, obtained through the first-stage learning, and the second internal codec. That is, the feature map latent representation ŷ, that has passed through the image encoding unit 140 and image decoding unit 230 that are actually used, and the format inverse conversion unit 240, is input, and then it can be learned to minimize the error between the input feature map latent representation and the original input feature map, or to maximize the final machine task performance.

Meanwhile, the loss function used for learning may be at least one of a loss for reducing distortion of an input feature map, such as MSE or MAE, or a loss for maximizing machine task performance, such as mAP or MOTA.

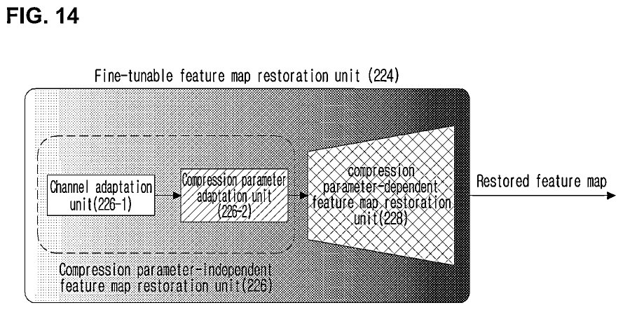

FIG. 14 illustrates a configuration of a fine-tunable feature map restoration unit according to an embodiment of the present disclosure.

Referring to FIG. 14, the fine-tunable feature map restoration unit (224) may include a compression parameter-independent feature map restoration unit (228) and a compression parameter-dependent feature map restoration unit (226). Meanwhile, the fine-tunable feature map restoration unit (224) may be implemented only with the compression parameter-independent feature map restoration unit (228) without the compression parameter-dependent feature map restoration unit (226).

The compression parameter-independent feature map restoration unit (228) may be trained to have a single neural network weight parameter set, regardless of the compression parameters of the image encoder. The compression parameter-independent feature map restoration unit (228) may have a configuration equivalent to the feature map restoration unit (222), or may be configured by excluding some components of the feature map restoration unit (222).

The compression parameter-dependent feature map restoration unit (226) may be trained to have a neural network weight parameter set that is adaptive to the compression parameters of the image encoder. Meanwhile, within the fine-tunable feature map restoration unit (224), the compression parameter-dependent feature map restoration unit (226) may be positioned before the compression parameter-independent feature map restoration unit (228). That is, the input of the fine-tunable feature map restoration unit (224) may be input to the compression parameter-dependent feature map restoration unit (226), and the output of the compression parameter-dependent feature map restoration unit (226) may be input to the compression parameter-independent feature map restoration unit (228).

Meanwhile, in the present disclosure, the compression parameter of the image encoder may determine the compression level of the image encoder. For example, the compression parameter may include a quantization parameter (QP) used in a codec such as AVC, HEVC, or VVC.

The compression parameter-dependent feature map restoration unit (226) may include at least one of the compression parameter adaptation unit (226-2) or the channel adaptation unit (226-1).

For example, the compression parameter-dependent feature map restoration unit (226) may be configured to include only the compression parameter adaptation unit (226-2), or may be configured to include both the compression parameter adaptation unit (226-2) and the channel adaptation unit (226-1). Alternatively, the compression parameter-dependent feature map restoration unit (226) may be configured to include only the channel adaptation unit (226-1).

The compression parameter adaptation unit (226-2) may be implemented using some components of the feature map restoration unit (222), or may be implemented using components separate from the feature map restoration unit (222).

Based on the above-described disclosure, the feature map encoding/decoding and learning method according to the present disclosure will be described in detail.

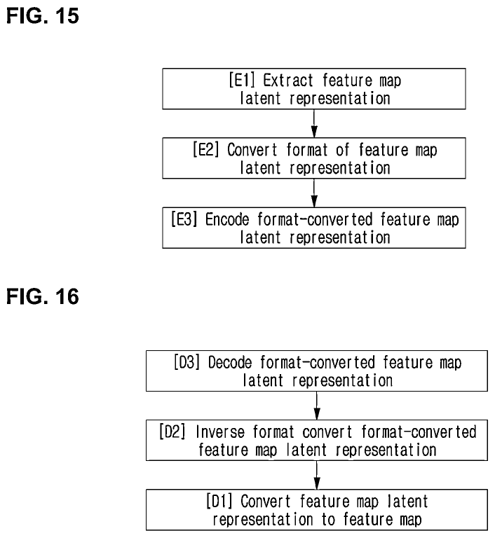

FIG. 15 and FIG. 16 are flowcharts of a feature map encoding method and a feature map decoding method according to the present disclosure, respectively.

Referring to FIG. 15, the image encoding method according to the present disclosure may include [E1] extracting a feature map latent representation, [E2] converting a format of the feature map latent representation, and [E3] encoding the format-converted feature map latent representation.

Referring to FIG. 16, the image decoding method according to the present disclosure may include [D3] decoding a format-converted feature map latent representation from a bitstream, [D2] performing inverse format conversion on the decoded format-converted feature map latent representation, and [D1] restoring a feature map from the inverted converted feature map latent representation.

Hereinafter, each step of FIG. 15 and FIG. 16 will be described in detail.

### [E1] Extracting Feature Map Latent Representation

The feature map encoding unit 110, specifically, the feature map latent representation extraction unit 112, extracts feature map latent representation from the input feature map.

At this time, the feature map latent representation extraction unit 112 may use parameters learned based on the neural network-based feature map latent representation entropy encoding unit 150 and the neural network-based feature map latent representation entropy decoding unit 250. That is, the feature map latent representation extraction unit 112 may extract feature map latent representation using parameters optimized through end-to-end learning.

The feature map latent representation extraction unit 112 may pad on the input feature map. When a neural network-based feature map latent representation extraction unit is used, there may be cases where the resolution of the input feature map does not match the acceptance condition of the neural network-based feature map latent representation unit. In this case, padding may be applied to the input feature map.

If padding is performed in the feature map latent representation extraction unit 112, an unpadding process may be performed in the feature map restoration unit 222 or the fine-tunable feature map restoration unit 224. Through the unpadding process, the restored feature map may be converted to the same resolution as the feature map before padding.

information on padding may be encoded and signaled so that the feature map restoration unit to perform unpadding.

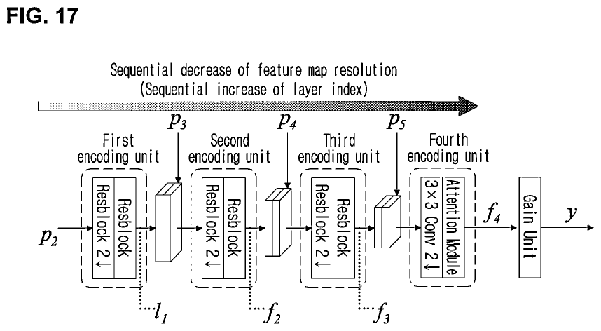

In particular, in order to extract feature map latent representation of a multi-layer feature map, it is necessary to reduce the amount of computation or model size. Accordingly, a sequential fusion encoding method, such as the example illustrated in FIG. 17, may be used.

FIG. 17 illustrates an example of extracting feature map latent representation through sequential fusion in the feature map latent representation extraction unit.

When a multi-layer feature map, e.g., P-layer feature map Pₖ (k is from 2 to 5) is input, each layer in the multi-layer feature map may be sequentially converted into a feature map latent representation.

For example, the first encoding block with p₂ as an input consists of Resblock and Resblock 2↓ and outputs an intermediate latent representation I₁. Here, ↓ represents ½ downsampled one.

The second encoding block consists of Resblock and Resblock 2↓ and outputs a fused latent representation f₂, in response to the inputs of I₁ and p₃.

The third encoding block consists of Resblock and Resblock 2↓ and outputs a fused latent representation f₃, in response to the inputs of f₂ and p₄.

The fourth encoding block consists of a 3×3 convolutional neural network layer (2↓) and an attention module and outputs the final feature map latent representation y (i.e., f₄) in response to the inputs of f₃ and p₅. Meanwhile, the specific configuration of the attention module may be understood by referring to the following references.

Z. Cheng et. al., “Learned image compression with discretized gaussian mixture likelihoods and attention modules,” in Proceedings of the IEEE/CVF Conference on Computer Vision and Pattern Recognition, 2020, pp. 7939-7948.

The input feature map to which padding is applied may be used as the input of the encoding block.

Specifically, an encoding block illustrated in FIG. 17 reduce the resolution of the input feature map of the predetermined layer by half, and the next block uses as input the concatenation of the output from the previous block (i.e., feature map of pre-determined layer that a resolution is reduced by half) and features map of a next layer that a resolution is half that the pre-determined layer. At this time, the resolution of the feature map of the next layer must be half the resolution of the previous layer for the encoding block to operate.

Specifically, since downsampling is finally performed four times on the first layer feature map P₂ by the encoding blocks illustrated in FIG. 17, it is desirable that the horizontal and vertical resolutions of P₂ be at least a multiple of 16. In addition, it is desirable that the resolution of P₃ be a multiple of 8, the resolution of P₃ be a multiple of 4, and the resolution of P₅ be a multiple of 2.

As above, the resolution of the feature map of each layer should be a multiple of a specific number. However, if the resolution of the input feature map does not satisfy the above restriction, padding may be performed on the feature map so that the resolution of the input feature map satisfies the above restriction (i.e., becomes a multiple of a specific number), and the padded feature map can be used as the input of the encoding block.

An embodiment of making the size of an input feature map a multiple of a specific number by the padding process of the present invention is described in detail.

It is assumed that the width of the input feature map is w, the height is h, and the variable m is a natural number expressed as an exponent of 2 (2ₙ). If w and h are not multiples of m, padding is performed so that the modified w′ and h′ become multiples of m.

Specifically, when the number of pixels to be added to the horizontal length of the feature map through padding is p_{w}, and the number of pixels to be added to the vertical length of the feature map through padding is pₕ, p_{w} and pₕ can be calculated by the following Equations 7 and 8. In Equations 7 and 8, % represents a modulo operation.

$${p}_{w} = m - ( w \% m ) \qquad [ Equation 7 ]$$

$${p}_{h} = m - ( h \% m ) \qquad [ Equation 8 ]$$

The p_{w} (i.e., the number of pixels to be added to the width of the feature map through padding) calculated through Equation 7 may represent the sum of the number of pixels to be padded on the left side of the feature map, p_{w}^{left}, and the number of pixels to be padded on the right side of the feature map, p_{w}^{right}, as in the example of Equation 9. In addition, p_{w}^{left} and p_{w}^{right} may be derived by Equations 10 and 11, respectively. In Equation 10, └ ┘ denotes a rounding down operation, and // denotes an integer division operation (i.e., discarding the remainder after the division operation and taking only the quotient).

$${p}_{w}^{left} + {p}_{w}^{right} = {p}_{w} \qquad [ Equation 9 ]$$

$${p}_{w}^{left} = {p}_{w} // 2 = ⌊ {p}_{w} \div 2 ⌋ \qquad [ Equation 10 ]$$

$${p}_{w}^{right} = {p}_{w} - {p}_{w}^{left} \qquad [ Equation 11 ]$$

Similarly, pₕ (i.e., the number of pixels to be added to the vertical length of the feature map through padding) calculated through Equation 7 may represent the sum of the number of pixels to be padded to the top of the feature map, pₕ^{up}, and the number of pixels to be padded to the bottom of the feature map, pₕ^{down}. In addition, pₕ^{up} and pₕ^{down} may be derived by Equations 12 and 13, respectively.

$${p}_{h}^{up} = {p}_{h} // 2 = ⌊ {p}_{h} \div 2 ⌋ \qquad [ Equation 12 ]$$

$${p}_{h}^{down} = {p}_{h} - {p}_{h}^{up} \qquad [ Equation 13 ]$$

When the input feature map is a multi-layer feature map, it is necessary to set m appropriately according to the structure of the feature map latent representation extraction unit 112 or the first internal codec. Specifically, when the feature map latent representation extraction unit 112 has a structure including the encoding blocks illustrated in FIG. 17 (i.e., when it is an appropriate structure in which the resolution of the I-th layer feature map is half of the resolution of the (I−1)-th layer feature map), the variable m may be set so as to satisfy the following Equation 14. In Equation 14, I and (I−1) represent indexes of layers. That is, m_{I} means the value of m used in the I-th layer. Meanwhile, I may have a value from 1 to L (L is the total number of layers).

$${m}_{l} = {m}_{l - 1} \div 2 \qquad [ Equation 14 ]$$

Additionally, depending on the type of the first internal codec used when learning the feature map latent representation extraction unit 112 and the feature map restoration unit 222, there may be restrictions on the resolution of the feature map latent representation. Specifically, when downsampling is performed two times in the first internal codec, the extracted feature map latent representation (i.e., y in FIG. 17) must have a horizontal and vertical resolution of at least 4. Accordingly, the horizontal and vertical resolution of the feature map of the last layer (L layer) with the smallest resolution among the input feature map must be at least 8. That is, it is preferable that my has a value greater than or equal to 8.

Based on the generated padding size, padding may be performed on the input feature map. Specifically, pixels as much as p_{w}^{left} can be added to the left of the feature map, pixels as much as p_{w}^{right} can be added to the right, pixels as much as pₕ^{up} can be added to the top, and pixels as much as pₕ^{down} can be added to the bottom.

Meanwhile, the value of the pixel added to the padding area may have a predefined value. Here, the predefined value may be 0. Alternatively, the value of the pixel to be added to the padding area may be copied or reflected from the edge of the feature map.

Here, reflection means filling the n-th line in the padding area with pixel values belonging to the n-th line from the boundary in the feature map. Here, the boundary in the feature map may represent a boundary adjacent to the padding area.

For example, the n-th line of the left padding area may be filled with pixel values belonging to the n-th line from the left boundary of the feature map, and the n-th line of the right padding area may be filled with pixel values belonging to the n-th line from the right boundary of the feature map.

Meanwhile, the feature map restoration unit 222, 224 may perform an unpadding process on the restored feature map. That is, by removing the padded area from the restored feature map, a feature map having the same resolution as the original feature map may be restored. Specifically, by removing an area of a left with p_{w}^{left} size, an area of a right with p_{w}^{right} size, an area of an upper with pₕ^{up} size, and an area with a lower with pₕ^{down} size of the restored feature map, a feature map having the same size as the original feature map may be obtained.

A feature map latent representation extraction unit may also be configured by combining the encoding block illustrated in FIG. 17 and neural network-based encoding blocks for image processing.

[D1] Restoring Feature Map from Feature Map Latent Representation

The fine-tunable feature map restoration unit 224 restores the inverse format converted feature map latent representation to the original feature map. Specifically, the fine-tunable feature map restoration unit 224 may restore the inverse format converted feature map latent representation to the original feature map using the learned neural network parameters.

The restored result may be used for performing a machine task or for learning of the feature map restoration unit 224.

The feature map for performing a machine task is encoded/decoded by the image encoding unit 140 and the image decoding unit 150, while the feature map for learning of the feature map restoration unit 224 may be encoded/decoded by the learnable entropy encoding unit 150 and the learnable entropy decoding unit 250.

Meanwhile, the learning of the feature map restoration unit 224 may be performed for each of the compression parameter-independent feature map restoration unit 228 and the compression parameter-dependent feature map restoration unit 226. Hereinafter, the learning process of the feature map restoration unit 224 will be described in detail.

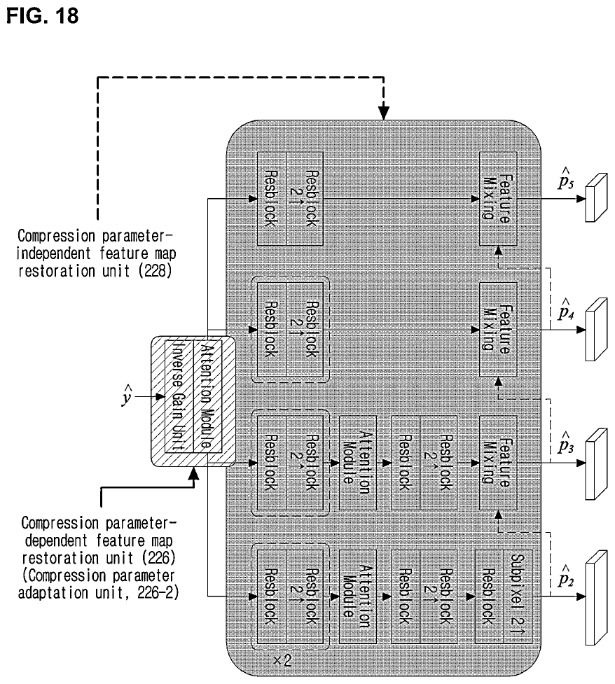

FIGS. 18 to 23 illustrate configuration diagrams of a fine-tunable feature map restoration unit including a compression parameter-independent feature map restoration unit and a compression parameter-dependent feature map restoration unit according to the present disclosure.

The example illustrated in FIG. 18 illustrates an example in which the inverse gain unit and the attention module on the input side of the feature map restoration unit 224 are included in a compression parameter-dependent feature map restoration unit 226, specifically, a compression parameter adaptation unit 226-2.

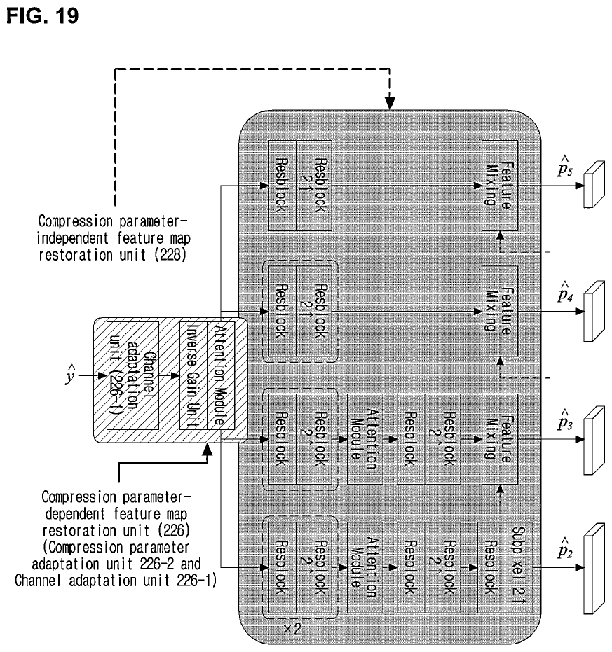

Alternatively, as in the example illustrated in FIG. 19, the compression parameter-dependent feature map restoration unit 226 may further include a channel adaptation unit 226-1 in the example of FIG. 18.

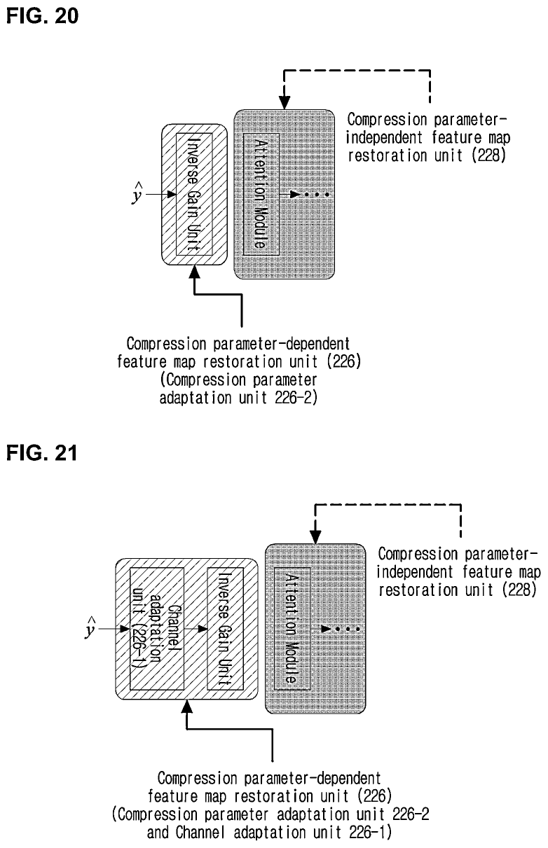

As another example, as in the example illustrated in FIG. 20, only the inverse gain unit may be included in the compression parameter-dependent feature map restoration unit 226, and the attention module may be included in the compression parameter-independent feature map restoration unit 228.

Alternatively, as in the example illustrated in FIG. 21, the compression parameter-dependent feature map restoration unit 226 may further include a channel adaptation unit 226-1 in the example illustrated in FIG. 20.

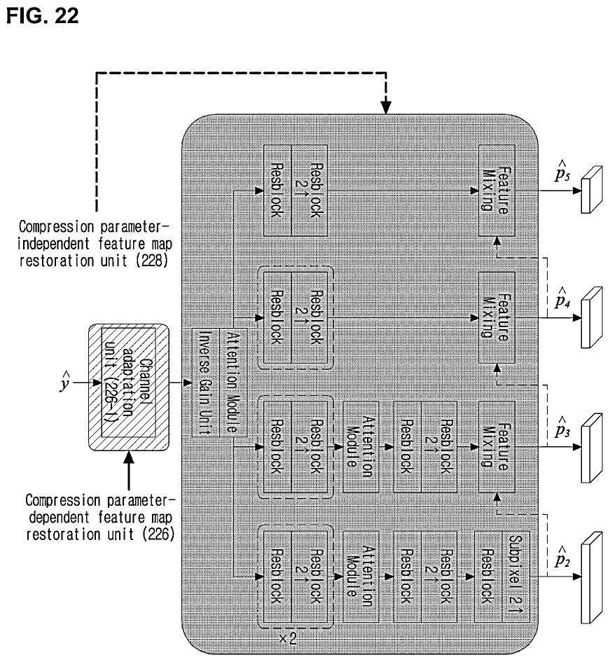

As another example, as in the example illustrated in FIG. 22, only the channel adaptation unit 226-1 may be set as the compression parameter-dependent feature map restoration unit 226. In addition, the general feature map restoration unit 222 may be set as the compression parameter-independent feature map restoration unit 228.

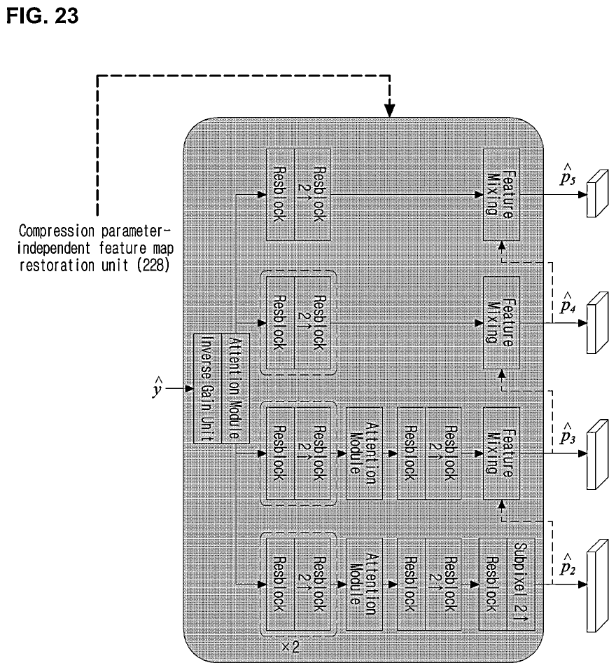

Meanwhile, the fine-tunable feature map restoration unit 224 may be composed of only the compression parameter-independent feature map restoration unit 228 without the compression parameter-dependent feature map restoration unit 226. FIG. 23 shows an example in which the fine-tunable feature map restoration unit 224 is composed of only the compression parameter-independent feature map restoration unit 228.

In addition to the feature map latent representation output from the inverse format conversion unit 240, the compression parameters of the image decoding unit may be additionally input to the fine-tunable feature map restoration unit 224. That is, the compression parameters added (or combined) to the feature map latent representation may be input to the fine-tunable feature map restoration unit 224.

Meanwhile, in order to add the compression parameters to the feature map latent representation restored in a channel-to-channel combination manner, it is necessary to convert the compression parameters into a representation with the same spatial resolution as the restored feature map latent representation. For this purpose, the one-hot encoding method may be applied.

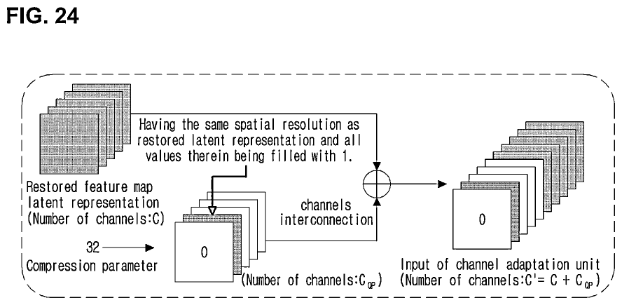

FIG. 24 shows an example of converting compression parameters using the one-hot encoding method.

The one-hot encoding method represents that a channel corresponding to the compression parameter value is filled with a value of 1, and all other channels are filled with a value of 0.

When the number of channels of the restored feature map latent representation is C, and the number of channels of the converted compression parameter is C_{QP}, combined data having a channel number of C′ (C+C_{QP}) is generated by combining the channels of the restored feature map latent representation and the converted compression parameter.

This results in increasing the number of channels input to the fine-tunable feature map restoration unit 224 from C to C′.

In order to solve the above problem, a channel adaptation unit 226-1 that converts combined data having a channel number of C′ back to a channel number of C may be used. In other words, the channel adaptation unit 226-1 may be a neural network-based module for converting input data having a channel number of C′ into data having a channel number of C.

Meanwhile, even if it passes through the channel adaptation unit 226-1, the spatial resolution of the input data may not change.

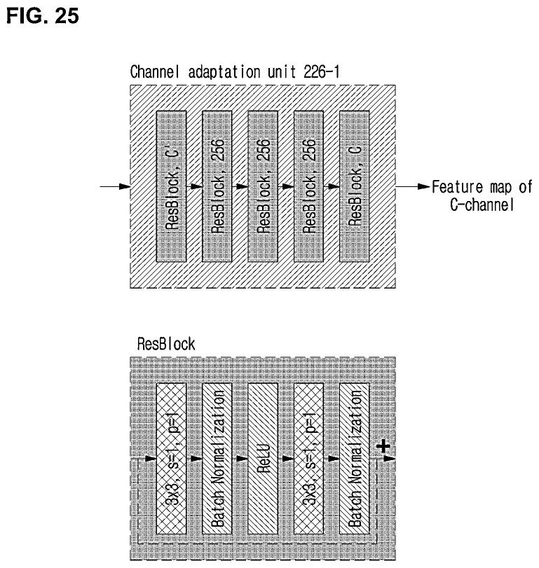

FIG. 25 illustrates a channel adaptation unit according to an embodiment of the present disclosure.

Meanwhile, the fine-tunable feature map restoration unit (224) may perform learning on compression parameters available to the image decoding unit (230).

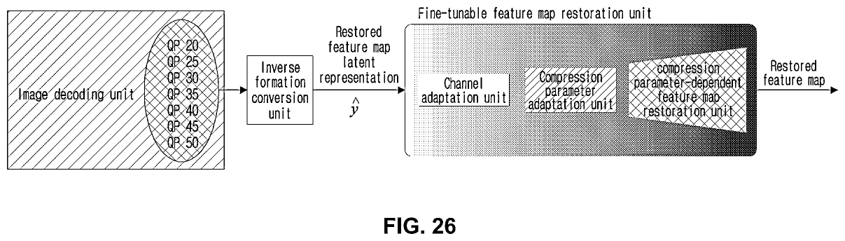

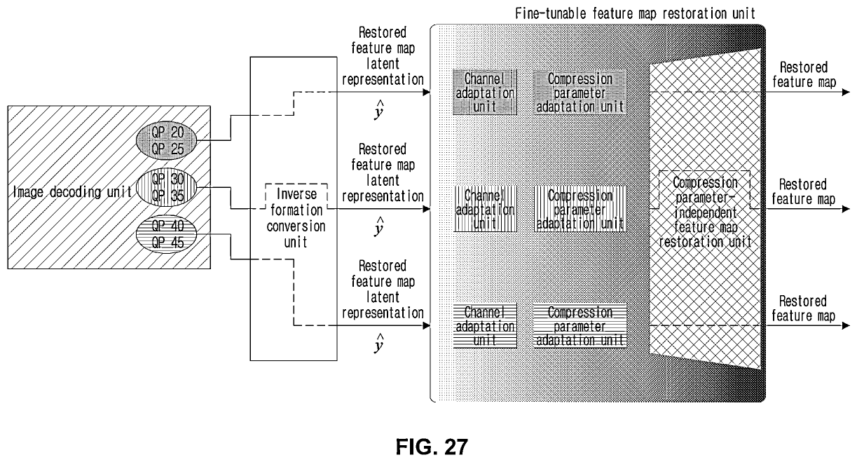

FIGS. 26 and 27 illustrate examples in which the fine-tunable feature map restoration unit performs fine-tuning learning on compression parameters available to the image decoding unit.

FIG. 26 illustrates an example in which the fine-tunable feature map restoration unit 224 performs fine-tuning learning on all compression parameters available to the image decoding unit 230.

By performing learning on all compression parameters available to the image decoding unit, a single fine-tunable feature map restoration unit 220, that can correspond to multiple compression parameters, may be obtained.

At this time, only the compression parameter-dependent feature map restoration unit 226 is trained based on the compression parameters available to the image decoding unit 230, and the compression parameter-independent feature map restoration unit 228 may be trained to have the same neural network weight parameters regardless of the compression parameters (i.e., for all compression parameters).

FIG. 27 shows an example in which compression parameters available in an image decoding unit are grouped, and a fine-tunable feature map restoration unit is trained for each group.

By performing training in units of groups, a trained neural network weight parameter of a feature map restoration unit 220 can be obtained for each of a plurality of groups.

That is, when the compression parameter used in the actual image encoding/decoding unit 140, 230 are determined, the feature map restoration unit 220 may restore the feature map using the neural network parameter corresponding to the group to which the compression parameter belongs.

Meanwhile, in FIG. 27, it is exemplified that two compression parameters are set as one group.

A group may include at least one compression parameter, and furthermore, the number of compression parameters included in each group may be different from each other.

The feature map restoration unit 220 may use the neural network parameters of the feature map restoration unit that are set as default. Alternatively, for the feature map restoration unit 220, a plurality of neural network parameter candidates may exist according to at least one of the type of the machine task model from which the feature map is extracted, the type of the machine task, or the splitting point of the machine task model from which the feature map is extracted. The feature map restoration unit 220 may use by one selected from the plurality of neural network parameter candidates. To this end, information indicating one of the plurality of neural network parameter candidates (e.g., feat_restoration_weight_idx) may be encoded and signaled.

In addition, when padding is performed in the feature map encoding unit 110, it is preferable that unpadding is performed in the feature map decoding unit 220. For the unpadding process, the resolution of the input feature map before padding is performed (e.g., ori_feat_wid, ori_feat_hei) may be encoded and signaled.

Let us assume that the horizontal length of the feature map after padding is performed is w_{pad}, and the vertical length of the feature map after padding is performed is h_{pad}. At this time, w_{pad} and h_{pad} can be calculated through the resolution of the restored latent representation feature map, the layer index, and the configuration of the feature map restoration unit. For example, it is assumed that the feature map restoration unit 224 is configured as in the example illustrated in FIG. 23, and the horizontal and vertical resolutions of the restored latent representation feature map are 4. In order to restore the feature map of the first layer (i.e., \hat{p}₂) in the multilayer feature map, the values of w_{pad} and h_{pad} of \hat{p}₂ can be determined as 64 because upsamplings are performed four times (i.e., increasing the width and height resolution by 16 times).

In addition, if the width and height of the feature map before padding are w and h, respectively, the number of pixels p_{w} added to the width of the feature map through padding and the number of pixels pₕ added to the height of the feature map through padding may be calculated using Equations 15 and 16.

$${p}_{w} = {w}_{pad} - w \qquad [ Equation 15 ]$$

$${p}_{h} = {h}_{pad} - h \qquad [ Equation 16 ]$$

As another example, in order to derive the horizontal padding size p_{w} and the vertical padding size pₕ, the variable m used in the padding process may be encoded and signaled. If the variable m is decoded, they can be calculated through Equations 7 and 8.

When p_{w} and pₕ are calculated as the above described embodiment, the number of pixels added to the left, right, top, and bottom of the feature map, (i.e., p_{w}^{left}, p_{w}^{right}, pₕ^{up}, and pₕ^{down}, respectively), can be calculated through Equations 10 to 13. Then, the unpadded feature map can be obtained by removing the number of padded pixels from the restored feature map. Specifically, the unpadding process can be performed by removing pixels as much as p_{w}^{left} on the left side of the feature map, pixels as much as p_{w}^{right} on the right side, pixels as much as pₕ^{up} on the top side, and pixels as much as pₕ^{down} on the bottom side.

### [E2] Converting a Format/[D2] Inverse-Converting a Format

In the format conversion unit (130), the extracted feature map latent representation may be converted to match the input format of the image encoding unit (140).

Specifically, the format conversion process may include arranging channels of the feature map latent representation and quantizing the feature map latent representation.

In the inverse format conversion unit (240), the output from the image decoding unit (230) is converted to the same format as the extracted feature map latent representation from the feature map extracting unit (110).

Specifically, the inverse format conversion process may include inverse quantizing the format-converted latent representation and rearranging the channels of the inverse format converted latent representation (i.e., restored latent representation).

Meanwhile, in order to perform the inverse conversion of the format conversion performed in the image encoder, the format conversion information should be transmitted to the image decoder.

For example, the number of bits n used to quantize the feature map latent representation and the range Rangeₘₐₓ of the latent representation may be encoded and transmitted to the inverse quantization unit of the inverse format conversion unit (240).

In addition, information indicating the arrangement method of the channels of the feature map latent representation may be encoded and signaled. The arrangement method may indicate one of the spatial arrangement method, the temporal arrangement method, or the spatiotemporal arrangement method.

Meanwhile, when the spatial arrangement method or the spatiotemporal arrangement method is used, information indicating the number of horizontal channels and the number of vertical channels constituting one frame may be additionally encoded and signaled.

Alternatively, the format conversion information as above may be predefined in the encoder and decoder.

Hereinafter, the format conversion and inverse conversion methods will be examined in detail.

### [E2-1/D2-2] Method for Arranging/Rearranging Channels of Feature Map Latent Expression

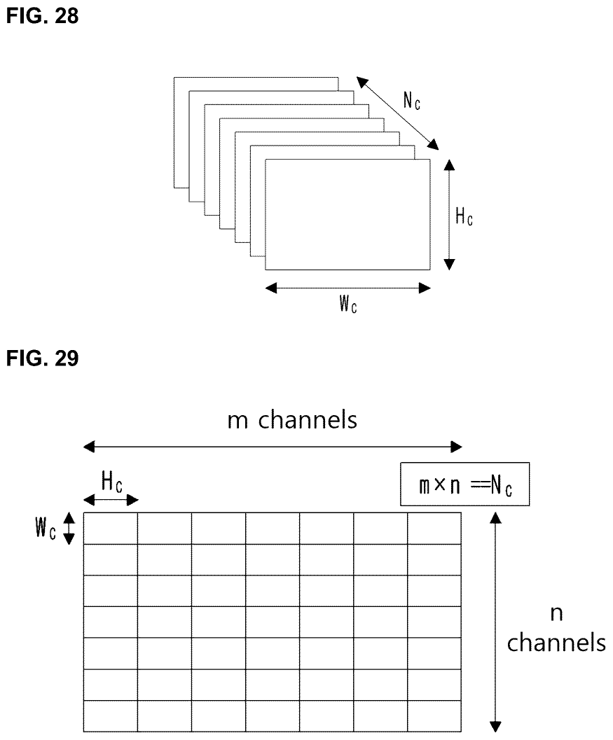

FIG. 28 illustrates a configuration of a general feature map.

As in the example illustrated in FIG. 28, the feature map may be composed of multiple channels. Specifically, in FIG. 28, the number of channels is represented as N_{c}, the horizontal size (i.e., width) of the channel is represented as W_{c}, and the vertical size (i.e., height) of the channel is represented as H_{c}.

In order to encode multiple channels, it is necessary to convert the multiple channels into a frame (i.e., picture) form, which is an input unit of the image encoding unit.

To this end, at least one of a spatial arrangement method, a temporal arrangement method, or a spatiotemporal arrangement method may be used.

FIGS. 29 to 31 illustrate a spatial arrangement method, a temporal arrangement method, and a spatiotemporal arrangement method, respectively.

As in the example illustrated in FIG. 29, the spatial arrangement method represents obtaining a single feature map latent representation frame by arranging channels of the feature map latent representation in a tile-like form.

The number of horizontal arrays m and the number of vertical arrays n may be set so that the product of each other is equal to the number of arranged channels N_{c}.

Information for determining the number of horizontal arrays m and the number of vertical arrays n may be encoded and signaled.

Alternatively, the image decoder (20) may decode the size information (e.g., pic_width_in_luma_samples and pic_height_in_luma_samples) of the image from the bitstream, and obtain the arrangement of the channels in the picture, i.e., the number of horizontal arrays and the number of vertical arrays, based on the resolution of the feature map. For example, a value of dividing the width of the picture (i.e., pic_width_in_luma_samples) by the width of the feature map may be derived as the number of horizontal arrays m, and a value of dividing the height of the picture (i.e., pic_height_in_luma_samples) by the height of the feature map may be derived as the number of vertical arrays n.

The spatially arranged feature map latent representation frame may be encoded/decoded in the image encoding unit and the image decoding unit based on the intra-frame prediction method.

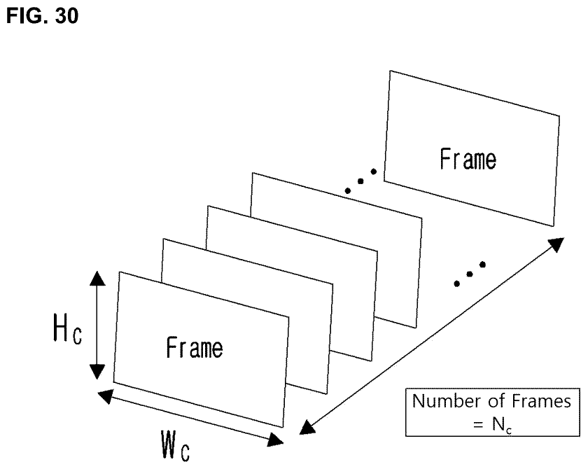

As shown in the example in FIG. 30, the temporal arrangement method indicates that each channel of the feature map latent representation is set as one frame.

Accordingly, the total number of frames generated by temporally arranging one feature map latent representation may be equal to the total number of channels N_{c} constituting the feature map latent representation.

The temporally arranged feature map latent representation frame may be encoded/decoded based on the inter-frame prediction method in the image encoding unit and the image decoding unit. Meanwhile, the temporal arrangement is generated by temporally arranging channels, and thus the intra-frame prediction may also be referred to as intra-channel prediction.

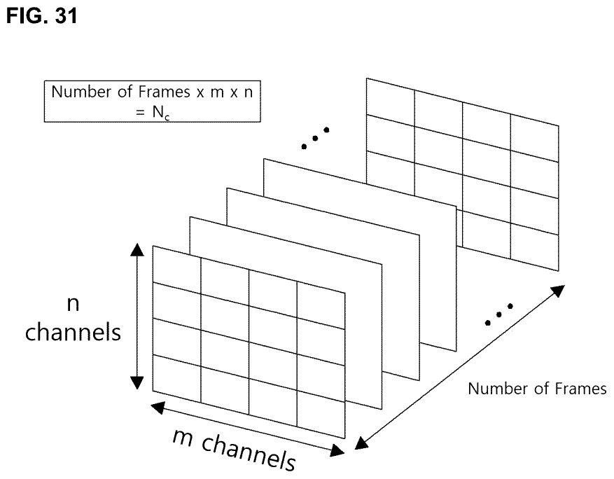

As shown in the example in FIG. 31, the spatiotemporal arrangement method indicates that spatially arranged frames are temporally arranged.

The product of the number of channels constituting one frame, m×n, and the total number of frames may be set to be equal to No.

The converted feature map frame is compressed by the image encoding unit (130) and restored by the image decoding unit (230).

The feature map latent representation frame decoded by the image decoding unit (230) may be restored to the original channel configuration through feature map rearrangement.

### [E2-2/D2-1] Method for Quantizing/Dequantizing the Converted Feature Map Latent Representation Frame

The feature map latent representation may be quantized in a method of uniform quantization or a method of non-uniform quantization. Specifically, the feature map latent representation may be quantized into an n-bit integer.

Equation 17 represents the n-bit uniform quantization process of the feature value F_{original}.

$$[ Equation 17 ]$$

$${F}_{converted} = Round ( ( {F}_{original} \times ( {2}^{n} - 1 ) / {Range}_{max} + {2}^{n - 1}$$

$$If ,$$

$${F}_{converted} > {2}^{n - 1} ,$$

$${F}_{converted} = {2}^{n - 1} ,$$

$${F}_{converted} < 0 ,$$

$${F}_{converted} = 0$$

Equation 18 represents the inverse uniform quantization process of the decoded feature value F_{converted}.

$$\hat{F} = ( \frac{( {\tilde{F}}_{converted} - {2}^{n - 1} )}{( {2}^{n} - 1 )} ) \times {Range}_{max} \qquad [ Equation 18 ]$$

In order to reduce errors occurring in the integerization process during quantization, a rounding operation may be applied. In addition, a process of clipping values exceeding the range that can be expressed as an n-bit integer may be added.

As shown in Equations 17 and 18, in order to perform quantization and inverse quantization, the number of bits n and the range Rangeₘₐₓ of the feature value are required. In order to use the same number of bits n and the range Rangeₘₐₓ of the feature value in the image decoder and the image encoder, the number of bits n and the range Rangeₘₐₓ of the feature value may be predefined in the image encoder and the image decoder. Alternatively, information for deriving at least one of the number of bits n and the range Rangeₘₐₓ of the feature value may be encoded by the image encoder and signaled to the image decoder.

The number of bits n may be set to a value that can be input to the image encoder, such as 8 or 10. Alternatively, it may be set to a smaller value, such as 4 or 6, to improve compression performance.

A value of Rangeₘₐₓ may be derived by subtracting the minimum value from the maximum value among the feature values to be encoded. Alternatively, a predefined value may be set as the value of Rangeₘₐₓ.

Alternatively, linear quantization may be performed based on the number of bits n and the maximum and minimum values among the feature values.

Equation 19 shows an example of performing inverse quantization on the decoded feature value F_{converted}.

$$[ Equation 19 ]$$

$$DequantizedPackedFeature = F\_converted / ( {2}^{( n - 1 )} ) * ( {F}_{{val}_{max}} - F\_val \_min ) + F\_val \_min$$

In Equation 19, F_val_max represents the maximum value among the feature values, and F_val_min represents the minimum value among the feature values. In order to perform inverse quantization, information representing the maximum and minimum values among the feature values may be encoded and signaled.

Meanwhile, quantization may be performed after arranging the latent representation or before arranging the latent representation. Similarly, inverse quantization of the latent representation may be performed before rearranging the latent representation or after rearranging the latent representation.

Meanwhile, if quantization is performed before arranging the latent representation, it would be desirable to perform inverse quantization before rearranging the latent representation to reduce the computational error.

### [E3]/[D3] Encoding Image/Decoding Image

In the image encoding unit 140, 150 of the image encoder 10, the converted feature map latent representation is encoded, so a bitstream is generated.

The image decoding unit 230, 250 may decode the bitstream and obtain the format-converted feature map latent representation.

For example, when performing image encoding/decoding for machine task, the image encoding unit 140 and the image decoding unit 230 are used, and when performing image encoding/decoding for learning an encoding model, the learnable entropy encoding unit 150 and the learnable entropy decoding unit 250 may be used.

Meanwhile, the image encoding unit 140 and the image decoding unit 230 may use an image compression codec such as HEVC or VVC.

In order to support the image encoding/decoding method described in the present disclosure, the following syntax structure/syntax elements may be defined.

Table 1 illustrates an example of a vision model parameter set including size information of the input image and the scaled image.

TABLE 1

```
vision_model_parameter_set_rbsp ( ) {
  vmps_vision_model_parameter_set_id
  img_wid
  img_hei
  scaled_img_wid
  scaled_img_hei
}
```

In Table 1, the syntax vmps_vision_model_parameter_set_id represents an identifier assigned to the VMPS structure.

The syntax img_width represents the width of the input image, and img_hei represents the height of the input image.

The syntax scaled_img_wid represents the width of the scaled input image, and scaled_img_hei represents the height of the scaled input image.

Table 2 shows an example of a feature sequence parameter set.

TABLE 2

```
feat_seq_parameter_set_rbsp ( ) {
fsps_feat_seq_parameter_set_id
  fsps_vision_model_parameter_set_id
  num_ori_feat_layers
  for (i = 0; i <= num_feature_layers; i++) {
    ori_feat_wid[i]
    ori_feat_hei[i]
    num_ori_feat_chan[i]
  }
  fused_feat_wid
  fused_feat_hei
}
```

In Table 2, the syntax fsps_feat_seq_parameter_set_id represents an identifier assigned to the FSPS (Feature Sequence Parameter Set).

The syntax fsps_vision_model_parameter_set_id represents an identifier of the vision model parameter set referenced by the FSPS.

The syntax num_ori_feature_layers represents the number of feature layers to be restored. In other words, the syntax num_ori_feature_layers represents the number of layers of the multi-layer feature map.

The syntax ori_feat_wid[i] represents the width of the original feature map in the layer whose index is i.

The syntax ori_feat_hei[i] represents the height of the original feature map in the layer whose index is i.

The syntax num_ori_feat_chan[i] represents the number of channels of the original feature map in the layer whose index is i. Meanwhile, the variable i may be 0 to (num_ori_feat_wid−1), inclusive.

The syntax fused_feat_wid represents the width of the fused feature map. Here, the fused feature may represent feature map latent representation extracted through the feature map encoding unit 110.

The syntax fused_feat_hei represents the height of the fused feature map.

Table 3 shows an example of a feature picture parameter set.

TABLE 3

```
feature_pic_parameter_set_rbsp( ) {
  fpps_feat_pic_parameter_set_id
  fpps_feat_seq_parameter_set_id
  inner_decoding_bypass_flag
  if(!inner_decoding_bypass_flag){
    feat_inner_decoder_info( )
  }
  dequant_bypass_flag
  if(!dequant_bypass_flag) {
    packed_feat_val_max
    packed_feat_val_min
  }
  unpacking_bypass_flag
  if(!unpacking_bypass_flag) {
    symmetric_feat_chan_flip_bypass_flag
  }
  feat_restoration_bypass_flag
  if(!feat_restoration_bypass_flag)
    feat_restoration_info( )
  }
}
```

In Table 3, the syntax fpps_feat_pic_parameter_set_id indicates the syntax assigned to the FPPS (Feature Picture Parameter Set).

The syntax fpps_feat_seq_parameter_set_id indicates the identifier of the FSPS referenced by the FPPS.

The syntax inner_coding_bypass_flag indicates whether the inner codec operates. For example, if the syntax inner_coding_bypass_flag is 1, the feature map latent representation extracted from the feature map latent representation extraction unit (112) may be transmitted as is to the feature map restoration unit (222).

On the other hand, if the syntax inner_coding_bypass_flag is 0, the feature map latent representation extracted from the feature map latent representation extraction unit (112) may be encoded through the internal encoding unit, and the bitstream generated as a result of the encoding may be transmitted to the image decoder (20).

The syntax dequant_bypass_flag indicates whether quantization/dequantization is performed. When the syntax dequant_bypas_flag is 1, quantization/dequantization is omitted. On the other hand, when the syntax dequant_bypass_flag is 0, quantization/dequantization is performed.

When the syntax dequant_bypass_flag is 0, information related to quantization/dequantization may be additionally encoded/decoded.

For example, the syntax packed_feat_val_max indicates the maximum value among the feature values in the arranged frame. In addition, the syntax packed_feat_val_min indicates the minimum value among the feature values.

The syntax unpacking_bypass_flag indicates whether feature rearrangement should be performed. When the syntax unpacking_bypass_flag is 1, feature rearrangement/rearrangement is not performed. On the other hand, if the syntax unpacking_bypass_flag is 0, it indicates that feature arrangement/rearrangement is performed.

If the syntax unpacking_bypass_flag is 0, information for performing feature rearrangement in the inverse format conversion unit (240) may be additionally encoded/decoded.

For example, the syntax symmetric_feat_chan_flip_bypass_flag indicates whether symmetric feature channel flipping rearrangement is allowed.

The syntax feature_restoration_bypass_flag indicates whether the feature map encoding and the feature map decoding are performed or not. For example, if the syntax feature_restoration_bypass_flag is 1, it indicates that the feature map encoding and decoding are not performed.

On the other hand, if the syntax feature_restoration_bypass_flag is 0, it indicates that the feature map encoding and the feature map decoding are performed. If the syntax feature_restoration_bypass_flag is 0, information for determining the neural network parameter of the feature map decoding unit may be additionally encoded/decoded.

Table 4 illustrates a syntax structure that includes syntax related to the internal codec.

TABLE 4

feat_inner_decoder_info( ) {
inner_coding_idx

In Table 4, the syntax inner_coding_idx indicates the type of codec used in the inner encoding unit and the inner decoding unit. The syntax inner_coding_idx may indicate one of multiple codecs. For example, a value of the syntax inner_coding_idx of 0 indicates that VVC is used to encode/decode an image in the inner encoding unit and the inner decoding unit.

Table 5 illustrates a syntax structure including syntax related to feature restoration.

TABLE 5

feat_restoration_info( ) {
feat_restoration_weight_idx
pad_size_min
}

In Table 5, the syntax feat_restoration_weight_idx specifies the neural network parameter for the feature map decoding unit. Specifically, a value of feat_restoration_weight_idx of 0 indicates that the neural network parameter for the detection task are used. A value of feat_restoration_weight_idx of 1 indicates that the neural network parameter for the segmentation task are used. A value of feat_restoration_weight_idx of 2 indicates that the neural network parameter for the features extracted from the machine task model segmentation points of ‘DN53 (DarkNet53)’ (i.e., the segmentation points defined for the TVD dataset in the Common Test and Training Conditions of MPEG FCM) are used when YOLO is used as the machine task model for the object tracking task. A value of feat_restoration_weight_idx of 3 indicates that the neural network parameter for the features extracted from the machine task model segmentation points of ‘ALT1’ (i.e., the split points defined for the HiEve dataset in the Common Test and Training Conditions of MPEG FCM) are used when YOLO is used as the machine task model for the object tracking task.

The syntax pad_size_min indicates the amount of padding (i.e., the size of the padding) applied to the layer with the smallest resolution.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A device for decoding a feature map, comprising:
an image decoding unit to decode an image from a bitstream;
an inverse format conversion unit to restore a feature map latent representation by converting a formation of a decoded image; and
a feature map restoration unit to restore a multi-layer feature map from the feature map latent representation,
wherein the feature map restoration unit restores the multi-layer feature map based on a learned neural network parameter.

2. The device of claim 1, wherein the feature map restoration unit comprises at least one of a compression parameter-dependent restoration unit, that is learned based on a compression parameter available for the image decoding unit, or a compression parameter-independent restoration unit, that is learned without considering the compression parameter available for the image decoding unit.

3. The device of claim 2, wherein the compression parameter represents a quantization parameter.

4. The device of claim 2, wherein the compression parameter-dependent restoration unit comprises:
a compression parameter adaptation unit learned by the compression parameters; and
a channel adaption unit adjusting a number of channels input to the compression parameter adaptation unit.

5. The device of claim 4, wherein the channel adaption unit is configured to convert a combined image, generated by combining channels of the feature map latent representation and the compression parameters, according to a number of channels of the feature map latent representation.

6. The device of claim 1, wherein the feature map restoration unit is firstly learned based on compression noise of a first internal codec, including an entropy encoding unit and an entropy decoding unit which are learnable by error back propagation.

7. The device of claim 6, wherein a neural network parameter, that is firstly learned, is fine-tuned based on compression noise of a second codec, including an image encoding unit and an image decoding unit which are not learnable by error back propagation.

8. The device of claim 4, wherein the inverse format conversion unit comprises:
an inverse quantization unit to perform inverse quantization on the decoded image; and
a channel rearrangement unit to perform a channel rearrangement for an inverse-quantized image.

9. The device of claim 7, wherein the inverse quantization is performed based on a maximum value and a minimum value among feature values, and
wherein information representing the maximum value and the minimum value is explicitly decoded from the bitstream.

10. The device of claim 8, wherein the channel rearrangement represents restoration of channels that are arranged in spatial, temporal or spatiotemporal into an original form.

11. A device for encoding a feature map, comprising:
a feature map latent extraction unit to extract a feature map latent representation from a multi-layer feature map;
a format conversion unit to convert a format of the feature map latent representation; and
an image decoding unit to generate bitstream by encoding a format-converted image,
wherein the feature map latent representation extraction unit extracts the feature map latent representation based on a learned neural network parameter.

12. The device of claim 11, wherein the device comprises:
a channel arrangement unit for performing channel conversion for the feature map latent representation; and
a quantization unit to perform a quantization on a channel converted image.

13. The device of claim 12, wherein the quantization is performed based on a maximum value and a minimum value among feature values, and
wherein information representing the maximum value and the minimum value is explicitly signaled via the bitstream.

14. The device of claim 8, wherein the channel arrangement represents arranging channels of the feature map latent representation in a spatial, temporal or spatiotemporal.

15. A method of decoding a feature map, comprising:
decoding an image from a bitstream;
restoring a feature map latent representation by converting a formation of a decoded image; and
restoring a multi-layer feature map from the feature map latent representation,
wherein restoring the multi-layer feature map is based on a learned neural network parameter.
